(19) United States
(12) Patent Application Publication
(10) Pub. No.: US 2017/0144421 A1
(43) Pub. Date: May 25, 2017

(54) ADHERING DEVICE AND ADHERING METHOD

(71) Applicant: 3M INNOVATIVE PROPERTIES COMPANY, St. Paul, MN (US)

(72) Inventors: Taishi Tokunaga, Yamato-city (JP); Tsuneharu Takeuchi, Kawasaki-shi (JP)

(21) Appl. No.: 15/318,436

(22) PCT Filed: Jun. 22, 2015
(86) PCT No.: PCT/US2015/036932

§ 371 Date: Dec. 13, 2016

(30) Foreign Application Priority Data
Jun. 24, 2014 (JP) 2014-129330

(51) Int. Cl. B32B 37/00; B32B 38/04; B32B 7/12; B32B 3/26; B31F 5/06; B31F 5/02

(52) U.S. Cl. CPC B32B 37/0053; B31F 5/06; B31F 5/022; B32B 7/12; B32B 3/266; B32B 38/04; B32B 2038/042

(57) ABSTRACT

An adhering device and an adhering method that can check that an article has been pressed at a predetermined pressing force at a predetermined location when pressing and adhering the article to an adhesive surface. The adhering device presses and adheres an article to an adhesive surface. The adhering device comprises a pressure roller having an outer peripheral face that presses the article, at least one projection provided on the outer peripheral face, and a support body that rotatably supports the pressure roller so that a central axis of the outer peripheral face becomes an axis of rotation. Rolling the pressure roller on the article with an appropriate pressing force forms holes on the surface of the article, and it can be confirmed that the pressing was properly performed.

### FIELD OF INVENTION

The present invention relates to an adhering device for pressing and adhering an article to an adhesive surface, and more particularly to an adhering device that can check that the article is pressed. Further, the present invention also relates to an adhering method using the adhering device.

### BACKGROUND ART

In automobile manufacturing, cardboard is sometimes adhered to the inner wall surface of a ceiling, a door, or a floor as a reinforcing member or a sound absorbing member. Double-sided tape is adhered to one side of the cardboard, and when working, after removing the peeling sheet of the double-sided tape, the cardboard is adhered by pressing it to a predetermined location of the inner wall surface of the ceiling or the like. This work is sometimes performed manually using an adhering device with a pressure roller. However, when manually doing this work, it is sometimes unclear during work or after work whether the cardboard has been pressed with the predetermined pressing force or where the cardboard has been pressed.

Similar problems, not limited to the adhering operation of cardboard, can also occur when manually adhering an article such as a rigid polyurethane foam board, a styrofoam board, a wooden board (plywood), and the like having one face that is an adhesive face to an adhesive surface using a pressure roller.

Note that a solution to this problem has not been conventionally known. There are jigs such as the one in Japanese Unexamined Patent Application Publication No. 2012-136237A, but that jig is for adhering tape and does not use a pressure roller, and is therefore clearly different from the field of the present invention.

### SUMMARY OF THE INVENTION

An object of the present invention is to provide an adhering device and an adhering method that can check that an article has been pressed at a predetermined pressing force at a predetermined location when pressing and adhering the article to an adhesive surface.

In one aspect of the present invention, an adhering device is provided that presses and adheres an article to an adhesive surface, the adhering device being provided with a pressure roller having an outer peripheral face that presses the article, at least one projection provided on the outer peripheral face, and a support body that rotatably supports the pressure roller so that a central axis of the outer peripheral face becomes an axis of rotation.

With the above configuration, a hole is formed in a surface of the article when the article is pressed by the pressure roller because there is a projection on the outer peripheral face of the pressure roller. The hole can be a through hole, blind hole, or a depression formed in the article. Because this hole is formed in the surface of the article, the locations on the article where it has been pressed can be confirmed. Further, by looking at the shape of the hole, it can also be confirmed whether the pressing force is in a predetermined range. For example, when the shape of the hole is small, the pressing force is small, and it can be known that there is a possibility that the adhering may not have been performed properly.

It can be desirable for the projection to be tapered toward its tip end portion. With this tapered shape, it can be easier to insert the projection into the article.

Further, it is suitable for a cross-section of a terminal portion of the projection to be the same along the entirety of a length direction of the terminal portion. According to this definition, for example, if the projection is circular cone-shaped, the terminal portion is cylindrical. After pressing the pressure roller by a certain pressing force or greater, the projection is inserted into the article up to the terminal portion. Therefore, by providing a terminal portion with this shape, it can be understood that a certain pressing force or greater was applied when visually confirming that the diameter of the holes to be formed is a certain value. Further, when the article is cardboard, the sound absorbency is improved by the formation of the holes, but if the diameter of these holes is a certain value, the sound absorbency is uniform along the entire face of the cardboard.

In addition, it is preferable for the tip end portion of the projection to be a substantially flat surface. When the tip end portion is a substantially flat surface, resistance occurs when inserting the projection into the article. The user knows when the projection is inserted into the article due to this resistance and can know by tactile sensation that the pressure roller has pressed the article at a predetermined pressing force. Further, when the tip end portion of the projection is a substantially flat surface, it is easy for a penetrating sound to occur at the moment it is inserted into the article, and it can also be audibly known that proper pressing has been performed.

In terms of the operability of the support body, it is effective to provide a handle extending in a direction away from the pressure roller.

Further, a first limiting mechanism that limits the rotation of the pressure roller when the pressing force applied to the pressure roller is a first predetermined value or less and a second limiting mechanism that limits the rotation of the pressure roller when the pressing force applied to the pressure roller is a second predetermined value that is greater than the first predetermined value or greater may be further provided. These limiting mechanisms allow the pressing force to be held at a predetermined range, and it becomes possible to surely perform adhering of the article.

Further, the present invention relates to an adhering method for pressing and adhering an article to an adhesive surface. This method includes the steps of: preparing the adhering device; disposing the article on the adhesive surface; and abutting the pressure roller of the adhering device to the article, applying pressing force to the pressure roller via the support body, and rolling the pressure roller on the article, and forms holes in the surface of the article due to a projection in the rolling step. Using this method, holes are formed in pressed locations on the surface of the adhering article, and it is possible to check during or after work.

As described above, the adhering device and the adhering method that uses this adhering device according to the present invention make it possible to confirm that the article has been pressed at a predetermined pressing force at a predetermined location when or after pressing and adhering the article to the adhesive surface.

### BRIEF DESCRIPTION OF DRAWINGS

FIG. 1 is a front view illustrating an adhering device of an embodiment according to the present invention.

FIG. 2 is a side view illustrating the adhering device in FIG. 1.

FIG. 3 is a cross-sectional view along a line III-III in FIG. 1.

FIG. 4 is an enlarged view illustrating a projection used in the adhering device illustrated in FIGS. 1 to 3.

FIG. 5 is an explanatory drawing illustrating an adhering method using the adhering device illustrated in FIGS. 1 to 3.

FIG. 6 is a drawing illustrating various modified examples of a projection.

### DETAILED DESCRIPTION OF THE INVENTION

Preferred embodiments of the present invention are described below in detail with reference to the drawings. Note that in all the drawings, identical or similar parts are assigned the same reference numeral and duplicate descriptions are omitted.

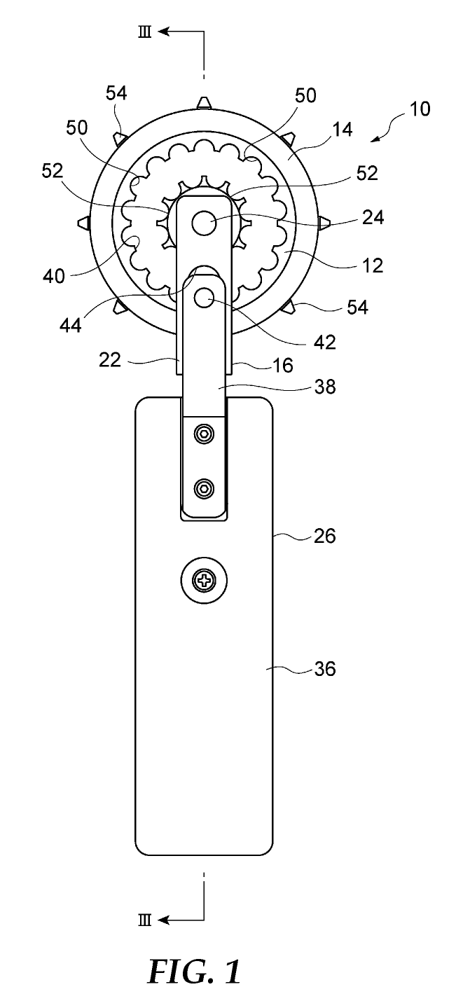

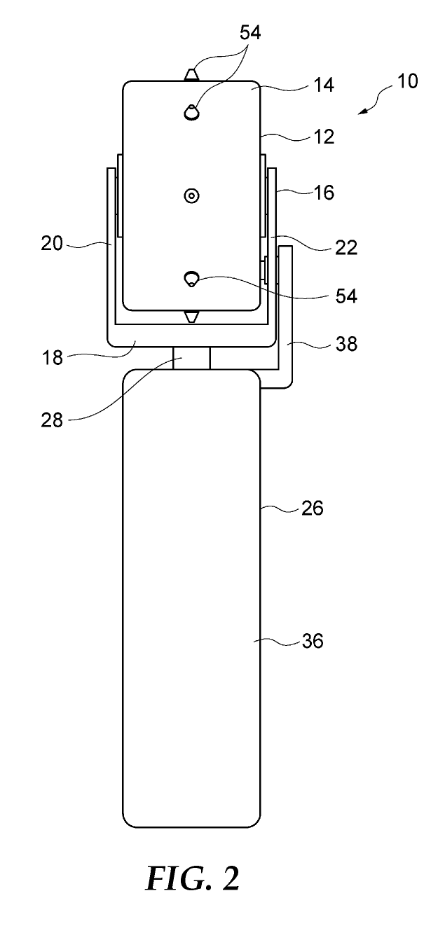

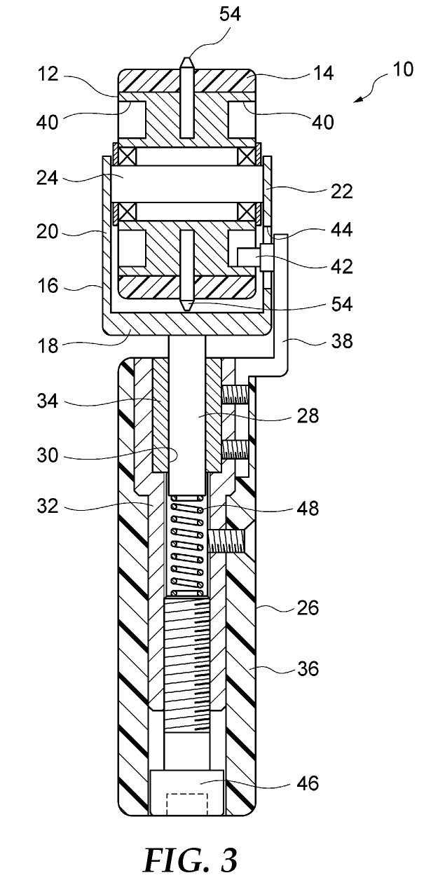

FIG. 1 is a front view illustrating an adhering device 10 of an embodiment according to the present invention, and FIG. 2 is a side view of the same. Furthermore, FIG. 3 is a cross-sectional view along the line III-III in FIG. 1. The adhering device 10 illustrated in the drawings is provided with a cylindrical pressure roller 12. A periphery of the pressure roller 12 is covered by an elastic member 14 such as rubber or an elastomer, a face to which the pressure roller 12 is pressed is protected, and an equal pressing force is applied in the width direction of the pressure roller 12.

The pressure roller 12 is rotatably supported by a support body 16. More specifically, the support body 16 is a U-shaped member including a base 18 and legs 20 and 22 that oppose each other and are folded from each end of the base 18, and a supporting axis 24 laterally bridged between the edges of the legs 20 and 22 is passed through a central hole of the pressure roller 12 and rotatably supports the pressure roller 12.

The support body 16 is provided with a handle 26 for the user to grip and handle the adhering device 10. In the embodiments illustrated, a shaft 28 is provided on the base 18 of the support body 16 extending in a direction away from the pressure roller 12, and this shaft 28 is slidably fitted into a through-hole 30 in a longitudinal direction of the handle 26 along an axis of the through-hole 30. Note that reference numeral 32 is a handle main body, reference numeral 34 is a bush for preventing wear between an inner face of the through-hole 30 and the shaft 28, and reference numeral 36 is a grip.

A stay 38 is fixed to a side face of the handle 26, and the stay 38 extends to a first side of the pressure roller 12. An annular groove 40 concentric with a central axis (axis in the central hole of the pressure roller 12) regulated by the outer peripheral face of the pressure roller 12 is formed in the side face of the pressure roller 12. An inward facing pin 42 provided on a tip end of the stay 38 passes through a long hole 44 of the leg 22 of the support body 16 extends in the opposing groove 40. By this, the coming off of the shaft 28 from the handle 26 can be avoided.

A spring force adjusting screw 46 is screwed to an end portion of the through-hole 30 on the opposite side of the pressure roller 12. A compression spring 48 is disposed between the spring force adjusting screw 46 and the shaft 28 of the support body 16 and biases the shaft 28 in a direction away from the handle 26. By this, when the adhering device 10 is not used, the pin 42 of the stay 38 extending from the handle 26 contacts a side wall face on the outer side of the groove 40.

A plurality of recesses 50 is formed in equal intervals in a circumferential direction in the side wall face on the outer side of the groove 40. Each recess 50 has a size that fits the pin 42, and limits the rotation of the pressure roller 12 when the pin 42 is fitted into any of the recesses 50. When the pressure roller 12 is pressed to the handle 26 side, the shaft 28 of the support body 16 is pushed into the handle 26 against the spring force of the compression spring 48, the pin 42 of the stay 38 separates from the recess 50, and the pressure roller 12 becomes rotatable. The force that pushes the pressure roller 12 into the handle 26 is nothing but the pressing force applied to the pressure roller 12 from the handle 26, and when this pressing force is a value (first predetermined value) or less determined by the compression spring 48, the rotation of the pressure roller 12 is limited, and the pressure roller 12 becomes rotatable when the first predetermined value is exceeded.

When the pressure roller 12 is further pressed into the handle 26 against the spring force of the compression spring 48, the pin 42 of the stay 38 abuts the side wall face on the inner side of the groove 40. A plurality of recesses 52 is also formed in equal intervals in the circumferential direction in the side wall face on the inner side, and when the pin 42 is fitted into this recess 52, the rotation of the pressure roller 12 is limited again. Therefore, when the pressing force applied to the pressure roller 12 reaches a second predetermined value that is greater than the first predetermined value or greater, the pressure roller 12 cannot be rotated.

Note that by spinning the spring force adjusting screw 46 changes the length of the compression spring 48, and it is thereby possible to adjust the first predetermined value and the second predetermined value.

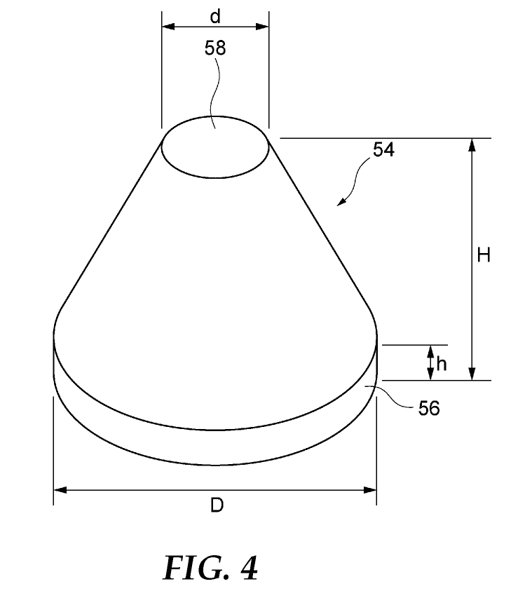

In the embodiment illustrated, a projection 54 is provided on the outer peripheral face of the pressure roller 12. As illustrated in FIGS. 1 to 3, it is preferable that a plurality of projections 54 is disposed at equal intervals in the circumferential direction in a position in the center of the width direction of the pressure roller 12, but as long as there is at least one projection, the positioning of such is not limited to that illustrated in the drawings. For example, the plurality of projections 54 may be positioned staggered. It is preferable that each of the projections 54 is tapered toward the tip end portion thereof, and in this embodiment, it is circular cone-shaped, as clarified in FIG. 4. Further, with the projection 54 illustrated in FIG. 4, the terminal portion 56 is cylindrical. Even further, this projection 54 is truncated, or in other words, the tip end portion is a substantially flat surface 58. The dimensions of the projection 54 can be appropriately determined, but when adhering the cardboard described below, it is suitable for an overall height H to be from approximately 2 mm to approximately 10 mm, a height h of the terminal portion 56 to be approximately 1 mm, a diameter D of the terminal portion 56 to be from approximately 2 mm to approximately 3 mm, and a diameter d of the substantially flat surface 58 of the tip end portion to be approximately 1 mm.

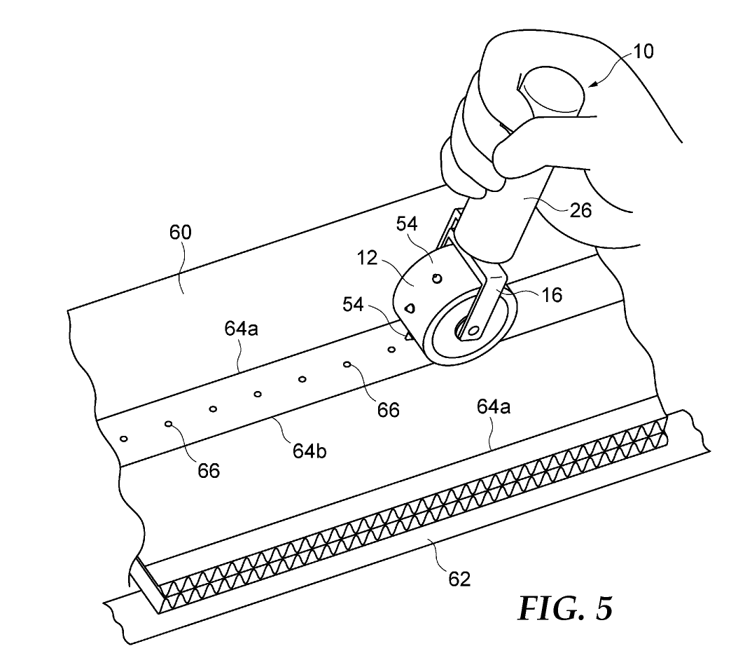

Next, an adhering method of an embodiment according to the present invention using the adhering device 10 with the configuration described above will be described. This embodiment is a case of adhering cardboard to an adhesive surface such as an inner wall surface of a ceiling of an automobile. As schematically illustrated in FIG. 5, cardboard 60 has a plurality of double-sided tape strips 62 adhered at regular intervals to the back side thereof. Note that the double sided tape 62 may be adhered randomly or uniformly to one face of the cardboard 60. Further, as illustrated in FIG. 5, guidelines 64a and 64b indicating the position of the double-sided tape 62 may be drawn.

First, the user removes a peeling sheet (not illustrated) from the double-sided tape 62 on the cardboard 60, disposes the cardboard 60 on a predetermined location on an adhesive surface, and the cardboard 60 is gently pressed by hand and temporarily adhered.

Next, the user grips the handle 26 of the adhering device 10, and the pressure roller 12 is abutted to a position on exactly the opposite side of the double-sided tape 62 on the surface of the cardboard 60 using the guidelines 64a and 64b as reference. Then, when the handle 26 is pressed to the cardboard 60 side, the pressure roller 12 becomes rotatable when the predetermined pressing force is exceeded, and the pressure roller 12 is rolled on the cardboard 60 along the guidelines 64a and 64b. By this, the pressure roller 12 presses the cardboard 60 with an appropriate pressing force (a force which exceeds the first predetermined value), and the cardboard 60 can be adhered to the adhesive surface. At the same time, it can be checked during or after work whether or not pressing has been surely performed in the desired location because the projection 54 of the pressure roller 12 continually forms holes 66 in the surface of the cardboard 60.

When the projection 54 is pressed into the cardboard 60 and forms the holes 66, it gives a small resistance to the user because the tip end portion of the projection 54 is the substantially flat surface 58, but the user can know by this resistance that pressing has been performed. Further, when the tip end portion of the projection 54 is the substantially flat surface 58, it is easy for a small penetrating sound to occur at the instant the projection 54 is pressed into the cardboard. The resistance and the penetrating sound are very effective for knowing whether pressing is being surely performed in work where the pressure roller 12 is hard to see.

Note that in this embodiment, when the pressing force applied to the handle 26 exceeds the first predetermined value and reaches the second predetermined value, the pin 42 of the stay 38 is fitted into the recess 52 of the groove 40 of the pressure roller 12, and the rotation of the pressure roller 12 is limited. Because of this, adhering work of the cardboard 60 is forcibly stopped, but an adverse effect of the cardboard 60 being recessed due to a large pressing force by the pressure roller 12 is suitably prevented.

Thus, the cardboard 60 is pressed to the adhesive surface at a proper pressing force between the first predetermined value and the second predetermined value, and adhering is surely performed. Here, in this embodiment, it should be noted that the terminal portion 56 of the projection 54 is cylindrical. When the terminal portion 56 of the projection 54 is cylindrical, a piercing amount of the projection 54 can be in a range where the terminal portion 56 is positioned, and the diameter of the holes 66 formed in the cardboard 60 can be substantially uniform when the pressing force is properly determined between the first predetermined value and the second predetermined value. This improves the appearance of the cardboard 60 after construction. Further, because it is understood that the holes 66 improve the sound absorbency of the cardboard 60, sound absorbency is evenly improved along the entire face of the card board 60 when the diameters are equal. Note that if even the terminal portion of the projection 54 is cylindrical, variation occurs in the diameter of the holes 66 to be formed even if the pressing force is between the first predetermined value and the second predetermined value.

In the above, the preferred embodiments of the present invention were described in detail, but the present invention is obviously not limited to these embodiments.

For example, in the embodiments described above, a mechanism (first limiting mechanism) that limits the rotation of the pressure roller 12 by the shaft 28 of the support body 16, the handle 26, the compression spring 48, the pin 42 of the stay 38, and the recess 50 on the outer side of the groove 40 and a mechanism (second limiting mechanism) that limits the rotation of the pressure roller 12 by the shaft 28 of the support body 16, the handle 26, the compression spring 48, the pin 42 of the stay 38, and the recess 52 on the inner side of the groove 40 are configured, but means of limiting rotation by friction is considered in addition to the fitting of the recess and the pin for these limiting mechanisms. Further, electrically operating the limiting mechanisms after detecting the pressing force is considered, and even further, a means for emitting an alarm when a pressing force outside a predetermined range occurs may be used for a kind of the limiting mechanism.

Further, the adhering device 10 without the first limiting mechanism, the second limiting mechanism, or only one of them also belongs to the present invention according to claim 1. In this case, by viewing the state of the holes 66 formed by the projection 54, it can be checked whether or not a pressing force was properly applied.

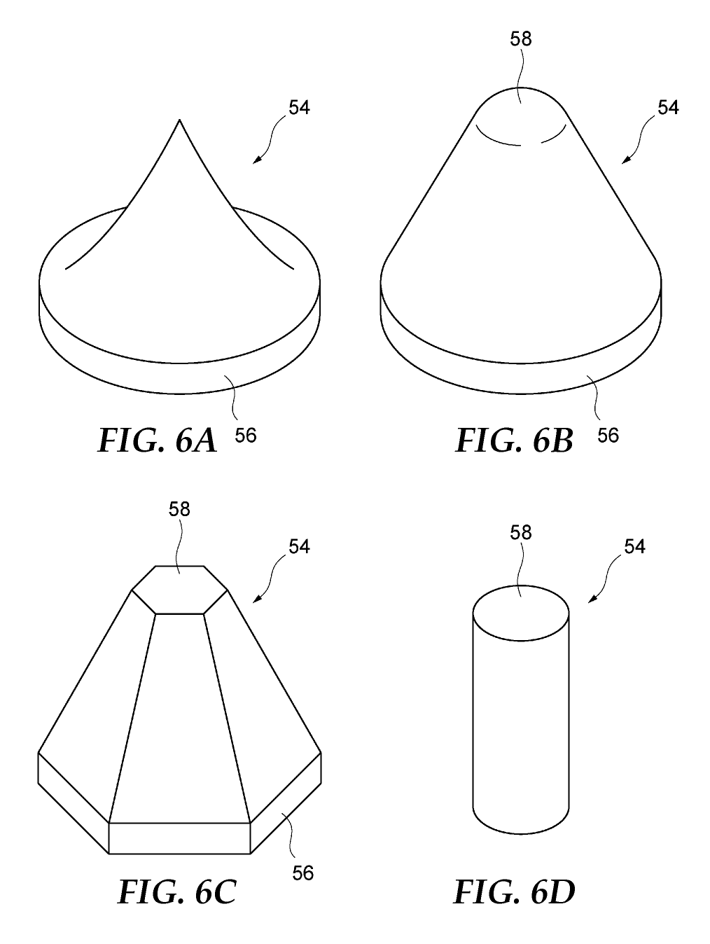

In addition, various shapes can be considered for the shape of the projection 54 as illustrated in FIG. 6. Note that the tip end of the projection 54 illustrated in FIG. 6A is spire-shaped, and the effect of the resistance and the penetrating sound described above cannot be achieved, but there is an effect of the rolling of the pressure roller 12 being smooth. Further, FIG. 6B illustrates that the shape of the tip end portion of the projection 54 is a slightly projecting curved surface, and there is no need for the tip end portion of the projection to be a perfectly flat surface. This kind of surface is also included as a substantially flat surface. FIG. 6C illustrates that the projection 54 may be a pyramid (six-sided pyramid) shape. Even in this kind of pyramid shape, it is preferable for the terminal portion 56 to be a prism, in other words, it is preferable for a cross-section (cross-section of the face normal to the axis of the projection 54 in the longitudinal direction) of the terminal portion 56 of the projection 54 along a predetermined length from the intersection of the projection 54 and the pressure roller 12 toward the tip end portion of the projection 54 to be the same along the entirety of the terminal portion 56. FIG. 6D illustrates the projection 54 with a cylindrical shape. With the cylindrical-shaped projection 54, the holes 66 formed in the surface of the article have a tendency to be long holes, and the degree of pressing can be checked by looking at the length of the holes 66.

Note that the terminal portion 56 of the projection 54 is illustrated projecting from the outer peripheral face of the pressure roller 12 in the above embodiment, but in the form in which the elastic member 14 of the pressure roller 12 is flexible and the elastic member 14 is easily deformed during pressing, the terminal portion 56 may be buried entirely or with only one portion in the elastic member 14. In this case, the elastic member 14 is recessed, and the terminal portion 56 of the projection 54 is exposed from the outer peripheral face of the pressure roller 12 when the pressure roller 12 is pressed to the article. As a result, it is easily understood that the effects described above are provided.

Further, the embodiments described above assume that cardboard is adhered to the inner wall surface of a ceiling or the like of an automobile, but the present invention is applicable to not just adhering cardboard, but can be used for adhering articles that depress under pressure such as rigid polyurethane foam board, styrofoam board, wooden board (plywood), rubber, foamed rubber and like, or articles that cause other changes on the surface (for example, coloring, lacerations and the like) to the inner face and the like of home walls or partition surfaces, and speaker boxes. The present invention is also applicable to articles that do not have double-sided tape but have one entire face that is an adhesive face, and in addition, the present invention is applicable when an adhesive face is provided on the adhesive surface.

1. An adhering device that presses and adheres an article to an adhesive surface, comprising:
a pressure roller having an outer peripheral face that presses the article;
at least one projection provided on the outer peripheral face; and
a support body that rotatably supports the pressure roller so that a central axis of the outer peripheral face becomes an axis of rotation,
wherein (1) the projection has a tip end portion that is a substantially flat surface, (2) the adhering device further comprises a first limiting mechanism that limits the rotation of the pressure roller when a pressing force applied to the pressure roller is not more than a first predetermined value, or (3) both (1) and (2).

2. The adhering device according to claim 1, wherein the projection is tapered toward the tip end portion of the projection.

3. The adhering device according to claim 1, wherein a cross-section of a terminal portion of the projection is the same along the entirety of a length direction of the terminal portion.

4. The adhering device according to claim 1, wherein the tip end portion of the projection is a substantially flat surface.

5. The adhering device according to claim 1, wherein the support body includes a handle extending in a direction away from the pressure roller.

6. The adhering device according to claim 1, further comprising a first limiting mechanism that limits the rotation of the pressure roller when a pressing force applied to the pressure roller is not more than a first predetermined value.

7. The adhering device according to claim 6, further comprising a second limiting mechanism that limits the rotation of the pressure roller when the pressing force applied to the pressure roller is not less than a second predetermined value that is greater than the first predetermined value.

8. An adhering method for pressing and adhering an article to an adhesive surface, comprising the steps of:
preparing the adhering device described in claim 1;
disposing the article on the adhesive surface; and
abutting the pressure roller of the adhering device to the article, applying a pressing force to the pressure roller via the support body, and rolling the pressure roller on the article,
holes being formed on the surface of the article due to the projection in the rolling step.

9. The adhering device according to claim 2, wherein a cross-section of a terminal portion of the projection is the same along the entirety of a length direction of the terminal portion.

10. The adhering device according to claim 2, wherein the tip end portion of the projection is a substantially flat surface.

11. The adhering device according to claim 3, wherein the tip end portion of the projection is a substantially flat surface.

12. The adhering device according to claim 4, wherein the support body includes a handle extending in a direction away from the pressure roller.

13. The adhering device according to claim 2, further comprising a first limiting mechanism that limits the rotation of the pressure roller when a pressing force applied to the pressure roller is not more than a first predetermined value.

14. The adhering device according to claim 13, further comprising a second limiting mechanism that limits the rotation of the pressure roller when the pressing force applied to the pressure roller is not less than a second predetermined value that is greater than the first predetermined value.

15. The adhering device according to claim 3, further comprising a first limiting mechanism that limits the rotation of the pressure roller when a pressing force applied to the pressure roller is not more than a first predetermined value.

16. The adhering device according to claim 15, further comprising a second limiting mechanism that limits the rotation of the pressure roller when the pressing force applied to the pressure roller is not less than a second predetermined value that is greater than the first predetermined value.

17. The adhering device according to claim 4, further comprising a first limiting mechanism that limits the rotation of the pressure roller when a pressing force applied to the pressure roller is not more than a first predetermined value.

18. The adhering device according to claim 17, further comprising a second limiting mechanism that limits the rotation of the pressure roller when the pressing force applied to the pressure roller is not less than a second predetermined value that is greater than the first predetermined value.

19. The adhering device according to claim 5, further comprising a first limiting mechanism that limits the rotation of the pressure roller when a pressing force applied to the pressure roller is not more than a first predetermined value.

20. The adhering device according to claim 19, further comprising a second limiting mechanism that limits the rotation of the pressure roller when the pressing force applied to the pressure roller is not less than a second predetermined value that is greater than the first predetermined value.
